(19) United States
(12) Patent Application Publication
(10) Pub. No.: US 2011/0100796 A1
(43) Pub. Date: May 5, 2011

(54) SYSTEM AND METHOD FOR PRODUCING SUPERCRITICAL OZONE

(75) Inventors: Hsien Chen MA, Xinfeng Township (TW); Fu Chieh YU, Shengang Township (TW); Chia Chen LIANG, Jiaoxi Township (TW); Chi Fan WANG, Taoyuan City (TW)

(73) Assignee: INDUSTRIAL TECHNOLOGY RESEARCH INSTITUTE, Chutung (TW)

(21) Appl. No.: 12/648,179

(22) Filed: Dec. 28, 2009

(30) Foreign Application Priority Data
Oct. 30, 2009 (TW) 098136825

(51) Int. Cl. C01B 13/11; B01J 19/08

(52) U.S. Cl. 204/176; 422/186.07

(57) ABSTRACT

A system for producing supercritical ozone includes a reactor having a first connecting port and a second connecting port, an ozone generator connected to the first connecting port, a fluid-driving device connected to the ozone generator and the second connecting port, and a fluid source connected to the reactor. The fluid-driving device is configured to circulate the gas in the reactor through the ozone generator. The fluid source is configured to increase the pressure in the reactor and thereby produce supercritical ozone.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

1. Field of the Invention

The present application relates to a system and a method for producing ozone, and relates more particularly to a system and a method for producing supercritical ozone.

2. Description of Related Art Including Information Disclosed Under 37 CFR 1.97 and 37 CFR 1.98

Ozone with a critical point close to carbon dioxide has an oxidizing power similar to that of fluorine. Moreover, ozone has disinfection capability, naturally decomposes in air, and does not leave any accumulated residue. Therefore, compared with toxic sterilants such as ethylene oxide, formaldehyde and peracetic acid, ozone is environmentally friendly. Due to the above-mentioned advantages, ozone is increasingly applied for sterilization or surface treatment.

Fluid in a supercritical state can have many characteristics. For example, compared with liquid phase medium in a reaction, supercritical fluid can have greater diffusivity, and therefore the supercritical fluid can encounter less mass transfer resistance when it flows through a porous solid catalyst or an interface; compared with gaseous phase medium in a reaction, the supercritical fluid has higher density so as to increase its reaction rate. U.S. Pat. No. 7,219,677 discloses a method and an apparatus for supercritical ozone treatment of a substrate. Oxygen is supplied to an ozone generator for producing ozone. After ozone is injected into deionized water, the ozonated mixture is pressurized to reach its supercritical state using a pressure-boosting pump and then is introduced into a reactor.

In addition, Taiwan Patent Application No. 200726514 discloses a method for producing a mixture of ozone and high pressure carbon dioxide. The method uses an adsorption bed to absorb oxidizer. Next, high pressure fluid flows through the adsorption bed for desorbing the oxidizer and to produce a mixture of oxidizer and high pressure fluid.

Furthermore, U.S. Patent Publication No. 2006/0,102,208 discloses a system for removing a residue from a substrate using supercritical carbon dioxide processing. In this system, the surface of a substrate is pretreated in a process chamber using ozone. Thereafter, the substrate is transferred to a supercritical carbon dioxide cleaning reactor using a transfer system, and thereupon supercritical carbon dioxide is introduced to clean the substrate. The cleaning process requires two reactors, and therefore the system is complex.

To bring ozone into its supercritical state requires a pressure-boosting pump. However, the pressure-boosting pump is expensive, and its sealing components are prone to the erosion effects of high pressure ozone, resulting in leakage issue.

### BRIEF SUMMARY OF THE INVENTION

Embodiments of the present disclosure propose a system and method for producing supercritical ozone, which is obtained by introducing high pressure fluid into a reactor to pressurize the gas containing ozone increasingly accumulated at atmospheric pressure in a circulating manner. Therefore, the system and method for producing supercritical ozone of the present disclosure can avoid leakage issue and reduce the cost of production of supercritical ozone.

One embodiment of the present disclosure proposes a system for producing supercritical ozone, which comprises a reactor, an ozone generator, a fluid-driving device, and a fluid source. The reactor includes a first connecting port and a second connecting port. The ozone generator connects to the first connecting port. The fluid-driving device connects to the ozone generator and the second connecting port such that the gas in the reactor can circulate through the ozone generator. The fluid source connects to the reactor, and is configured to pressurize the reactor to an operating pressure to obtain supercritical ozone.

Another embodiment of the present disclosure proposes a method for producing supercritical ozone, which comprises the steps of: circulating gas in a reactor through an ozone generator; and pressurizing the reactor to an operating pressure using pressurized fluid to obtain supercritical ozone.

To better understand the above-described objectives, characteristics and advantages of the present application, embodiments, with reference to the drawings, are provided for detailed explanations.

### BRIEF DESCRIPTION OF THE SEVERAL VIEWS OF THE DRAWINGS

The application will be described according to the appended drawings in which:

FIG. 1 is a schematic view of a system for producing supercritical ozone according to one embodiment of the present disclosure; and

FIG. 2 is a schematic view of a system for producing supercritical ozone according to another embodiment of the present disclosure.

### DETAILED DESCRIPTION OF THE INVENTION

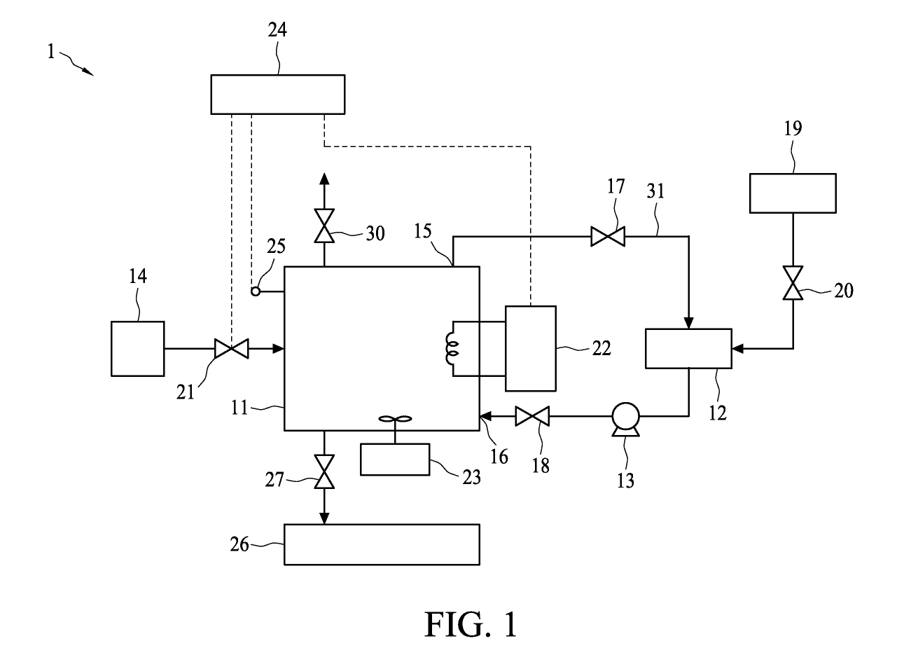

FIG. 1 is a system 1 for producing supercritical ozone according to one embodiment of the present disclosure. The system 1 for producing supercritical ozone comprises a reactor 11, an ozone generator 12, a fluid-driving device 13, and a fluid source 14. The reactor 11 comprises a first connecting port 15 and a second connecting port 16. In one embodiment of the present disclosure, the first connecting port 15 is a fluid outlet and the second connecting port 16 is a fluid inlet. However, the present disclosure is not limited to such arrangement.

The ozone generator 12 is coupled to the first connecting port 15, and a valve 17 is used to control the fluid flow between the reactor 11 and the ozone generator 12. The fluid-driving device 13 is coupled to the ozone generator 12 and the second connecting port 16, and a valve 18 can be disposed between the fluid-driving device 13 and the second connecting port 16 to control the fluid flow between the reactor 11 and the fluid-driving device 13. The fluid-driving device 13 draws the gas in the reactor 11 from the first connecting port 15 at atmospheric pressure, causing the gas to flow through the ozone generator 12 so as to convert oxygen in the gas into ozone. The gas with higher ozone concentration is then driven back to the reactor 11 by the fluid-driving device 13. Such a circulation process can continuously increase the ozone concentration in the reactor 11. In one embodiment, the fluid-driving device 13 comprises a circulating pump. Because the concentration of ozone is increased under atmospheric pressure, the leakage issue caused by the erosion of high pressure ozone can be avoided. Using a simple ozone generator 12 to produce ozone can prevent generated ozone from containing impurities, and allows the system 1 to have a simple structure and low manufacturing cost.

The system 1 for producing supercritical ozone of one embodiment of the present disclosure may further comprise an oxygen supply 19 configured to connect to the ozone generator 12 for provision of oxygen used for producing ozone. The oxygen supply 19 may comprise an oxygen cylinder or a tank containing compressed air, to which a compressed air pump can be connected for providing compressed air. Between the oxygen supply 19 and the ozone generator 12, a valve 20 can be provided.

As shown in FIG. 1, the reactor 11 additionally connects to a fluid source 14 configured to supply pressurized fluid, which can be introduced into the reactor 11 to pressurize the reactor 11 to an operating pressure. When the pressure in the reactor 11 is increased to the operating pressure, the ozone in the reactor 11 can achieve to its supercritical state so as to obtain supercritical ozone. In one embodiment of the present disclosure, the fluid source 14 can provide liquid carbon dioxide. Introducing the liquid carbon dioxide into the reactor 11 to pressurize the interior of the reactor 11 to above 55 bars and raising the interior temperature of the reactor 11 to above minus 12 degrees Celsius can cause ozone to reach the supercritical condition. Further, a valve 21 can be disposed between the fluid source 14 and the reactor 11 to control the fluid flow into the reactor 11. In another embodiment, by providing sufficient liquid carbon dioxide to pressurize the reactor 11 to above 70 bars and raising the interior temperature of the reactor to above 30 degrees, a mixture of supercritical ozone and supercritical carbon dioxide can be obtained. The system 1 for producing supercritical ozone of one embodiment of the present disclosure needs only a single reactor 11 so that the system 1 has a simple structure, low manufacturing cost and a space-saving advantage.

The reactor 11 can be connected with a temperature regulation device 22 for controlling the temperature of the interior of the reactor 11. The temperature regulation device 22 comprises a heater, a cooler, and a temperature controller, but the disclosure is not limited to the afore-mentioned components. The temperature controller controls the heating and cooling to achieve constant temperature control. The temperature controller can be a PID (proportion, integration, and differentiator) controller.

The system 1 for producing supercritical ozone may further comprise a stirrer 23, which is used when a stirring operation is required. For example, the supercritical ozone and non-sterile liquid can be mixed using the stirrer. The stirrer 23 can be a mechanical stirrer or a magnetic stirrer; however, the present disclosure is not limited to the two examples.

The system 1 for producing supercritical ozone may also comprise a controller 24 configured to use control parameters to control the system 1. For example, the controller 24 can be connected to the temperature regulation device 22 to control the interior temperature of the reactor 11, or the controller 24 can be connected to the valve 21 to control the interior pressure of the reactor 11. The reactor 11 can be disposed with sensors 25 such as temperature sensors or pressure sensors which are connected to the controller 24 to monitor the interior environment of the reactor 11.

After reaction is completed, the gas in the reactor 11 can be directed through the ozone decomposer 26 to convert ozone to oxygen. A valve 27 can be disposed between the ozone decomposer 26 and the reactor 11. The ozone decomposer 26 can comprise activated carbon to decompose ozone, a catalyst such as manganese dioxide to decompose ozone, or a heater to convert ozone to oxygen by heat. The reactor 11 can be a stainless steel enclosed cabin, which can include a pressure vent 30.

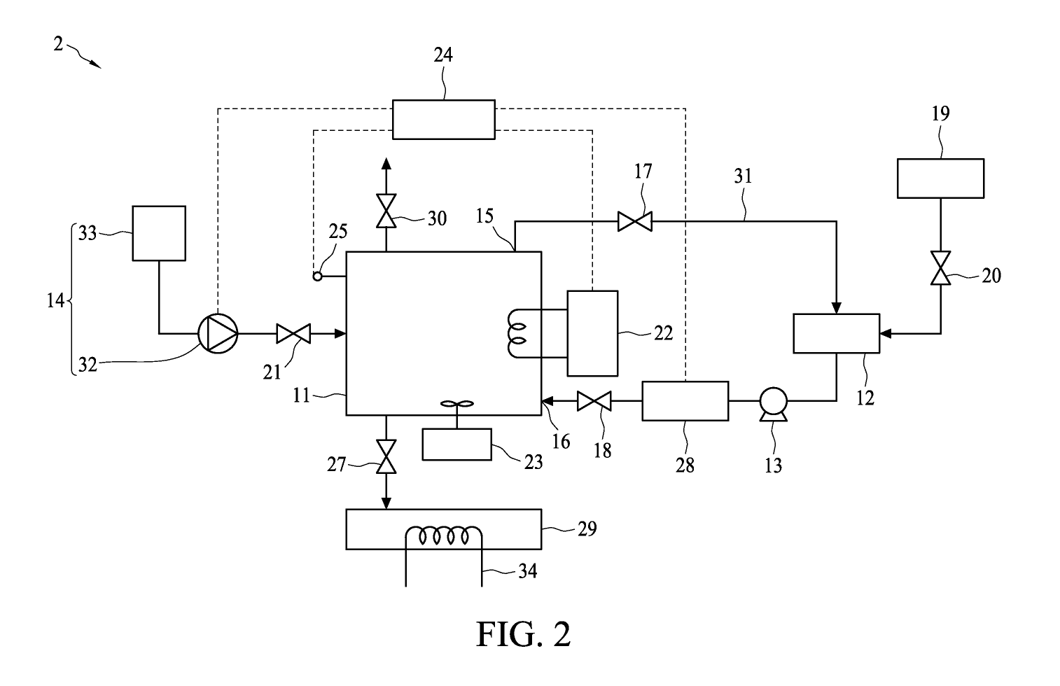

FIG. 2 is a system 2 for producing supercritical ozone according to another embodiment of the present disclosure. The system 2 for producing supercritical ozone comprises a reactor 11 having a first connecting port 15 and a second connecting port 16. A circulation loop 31 is disposed exterior to the reactor 11 and connects to the first connecting port 15 and the second connecting port 16. An ozone generator 12, a fluid-driving device 13, and an ozone analyzer 28 are separately disposed in the circulation loop 31. A fluid source 14, a temperature regulation device 22, and a stirrer 23 are individually connected to the reactor 11.

The ozone analyzer 28 disposed in the circulation loop 31 is for monitoring an ozone concentration, and can be connected to the controller 24 to control the ozone concentration in the reactor 11. The fluid source 14 may comprise a booster pump 32 with a gas source 33 connected to the booster pump 32. The gas source 33 can be a carbon dioxide source, but the present disclosure is not limited to such example. The booster pump 32 is for increasing the pressure in the reactor 11 so as to bring the ozone in the reactor to the supercritical state. The booster pump 32 can be coupled to the controller 24, whereby the pressure in the reactor 11 can be controlled.

The system 2 for producing supercritical ozone may comprise a carbon dioxide recovery device 29 configured to recover the carbon dioxide used in producing supercritical ozone. The carbon dioxide recovery device 29 may include a heater 34 configured to decompose the ozone mixed with the carbon dioxide.

The above-described ozone generator 12 may comprise a corona discharge ozone generator, an ultraviolet ozone generator, or a plasma ozone generator, but the present disclosure is not limited to such examples. The ozone generator 12 converts a portion of oxygen contained in the gas flowing therethrough into ozone to increase the ozone concentration of the gas.

Moreover, when the system 2 for producing supercritical ozone is operated, the interior temperature of the reactor 11 can be controlled within a range of from 30 to 80 degrees Celsius using the temperature regulation device 22, and the interior pressure of the reactor 12 can be increased to a pressure in a range of from 70 to 300 bars.

Referring back to FIGS. 1 and 2, one embodiment of the present disclosure proposes a method for producing supercritical ozone. The method initially opens the valves 17, 18, and 20. After the valve 20 is opened, the oxygen in the oxygen supply 19 flows into the ozone generator 12, which converts a portion of inflowing oxygen into ozone. A mixture of oxygen and ozone then flows into the reactor 11 following the circulation loop 31. Next, the valve 20 is closed, and the gas in the reactor 11 is circulated around the circulation loop 31 and through the ozone generator 12 using the fluid-driving device 13. The ozone generator 12 converts the oxygen in the circulating gas into ozone so that the ozone concentration of the gas in the reactor 11 can be continuously increased. Thereafter, when the ozone concentration in the reactor 11 reaches a predetermined level, the valves 17 and 18 are closed, and the valve 21 is opened, and high pressure fluid flows into the reactor 11 from the fluid source 14 until the reactor 11 reaches the supercritical state of ozone. In this method, the ozone concentration can be increased to 1000 ppm, but the present disclosure is not limited to such an example.

As shown in FIG. 1, the fluid source 14 can be directly coupled to the reactor 11. The fluid source 14 can provide liquid carbon dioxide, which is introduced into the reactor 11 to pressurize the reactor 11 to above 55 bars. The interior temperature of the reactor 11 can be controlled to above minus 12 degrees Celsius using the temperature regulation device 22. Consequently, the ozone in the reactor 11 can reach the supercritical state. Alternatively, the pressure of the reactor 11 can be increased to 70 bars, and the interior temperature of the reactor 11 can be maintained above 30 degrees Celsius so as to obtain a mixture of supercritical ozone and supercritical carbon dioxide. In the embodiment of FIG. 2, the booster pump 32 pumps the gas stored in the gas source 33 into the reactor 11 to increase the pressure in the reactor 11 to a value in a range from 70 to 300 bars, and the interior of the reactor 11 can simultaneously be controlled to a temperature in a range of from 30 to 80 degrees Celsius, thereby obtaining a mixture of supercritical carbon dioxide and supercritical ozone.

The reactor 11 can hold non-sterile liquid. After the formation of supercritical fluid including supercritical carbon dioxide and supercritical ozone, a stirrer 23 can be utilized to sufficiently mix the supercritical fluid with the non-sterile liquid in order to sterilize the liquid. The system and method of the embodiments of the present disclosure are not limited to the sterilization application, and can be also used for other applications such as substrate surface cleaning, the oxidative modification of a material surface, wafer etching, and the disinfection and sterilization of medical devices.

After the sterilization process is finished, the pressure in the reactor 11 is reduced to atmospheric pressure. Referring to FIG. 1, the valve 27 is opened, and the gas in the reactor 11 flows through an ozone decomposer 26 to decompose ozone. As shown in FIG. 2, after the valve 27 is opened, the gas in the reactor 11 enters the carbon dioxide recovery device 29. The carbon dioxide in the gas is recovered and the ozone in the gas is decomposed by the heater 34.

In summary, the disclosure proposes a system for producing ozone comprising a circulation loop disposed with an ozone generator, which is used to increase the ozone concentration in the reactor by circulating the fluid in the reactor at atmospheric pressure. The system further includes a fluid source containing high pressure fluid, which is introduced into the reactor so that the ozone in the reactor can reach the supercritical state.

The above-described embodiments of the present application are intended to be illustrative only. Numerous alternative embodiments may be devised by persons skilled in the art without departing from the scope of the following claims.

We claim:

1. A system for producing supercritical ozone, comprising:
a reactor including a first connecting port and a second connecting port;
an ozone generator connected to the first connecting port;
a fluid-driving device connected to the ozone generator and the second connecting port, the fluid-driving device being configured to circulate gas in the reactor through the ozone generator; and
a fluid source connected to the reactor and configured to pressurize the reactor to an operating pressure to obtain supercritical ozone.

2. The system for producing supercritical ozone of claim 1, wherein the fluid source comprises a liquid carbon dioxide source, or a booster pump and a carbon dioxide source connected to the pressurizing device.

3. The system for producing supercritical ozone of claim 2, wherein the operating pressure is in a range of from 70 to 300 bars.

4. The system for producing supercritical ozone of claim 2, further comprising a controller coupled to the pressurizing device to control the operating pressure.

5. The system for producing supercritical ozone of claim 2, further comprising a carbon dioxide recovery device including a heater configured for decomposition of ozone.

6. The system for producing supercritical ozone of claim 2, further comprising a temperature regulation device connected to the reactor for controlling temperature of the interior environment of the reactor.

7. The system for producing supercritical ozone of claim 6, wherein the temperature of the reactor is in a range of from 30 to 80 degrees Celsius.

8. The system for producing supercritical ozone of claim 6, further comprising a controller coupled to the temperature regulation device for controlling the temperature of the reactor.

9. The system for producing supercritical ozone of claim 1, wherein the ozone generator comprises a corona discharge ozone generator, an ultraviolet ozone generator, or a plasma ozone generator.

10. The system for producing supercritical ozone of claim 1, further comprising an oxygen supply connected to the ozone generator.

11. The system for producing supercritical ozone of claim 10, wherein the oxygen supply comprises an oxygen cylinder.

12. The system for producing supercritical ozone of claim 1, further comprising a stirrer configured to stir the supercritical ozone.

13. The system for producing supercritical ozone of claim 12, wherein the stirrer includes a mechanical stirrer or a magnetic stirrer.

14. The system for producing supercritical ozone of claim 1, further comprising an ozone analyzer disposed between the reactor and the fluid-driving device.

15. The system for producing supercritical ozone of claim 1, further comprising an ozone decomposer connected to the reactor.

16. A method for producing supercritical ozone, comprising steps of:
circulating gas in a reactor through an ozone generator; and
pressurizing the reactor to an operating pressure using pressurized fluid to obtain supercritical ozone.

17. The method of claim 16, wherein the pressurized fluid comprises liquid carbon dioxide.

18. The method of claim 16, wherein the step of pressurizing the reactor comprises a step of pumping carbon dioxide into the reactor using a booster pump.

19. The method of claim 18, further comprising a step of recovering the carbon dioxide.

20. The method of claim 17, further comprising a step of recovering the carbon dioxide.

21. The method of claim 16, further comprising steps of:
providing non-sterile liquid; and
mixing the non-sterile liquid with the supercritical ozone.

22. The method of claim 16, wherein the step of circulating gas in a reactor comprises a step of increasing an ozone concentration to 1000 ppm.

23. The method of claim 16, wherein the operating pressure is in a range of from 70 to 300 bars.

24. The method of claim 16, further comprising a step of regulating a temperature of the reactor within a range of from 30 to 80 degrees Celsius.

25. The method of claim 16, wherein the ozone generator comprises a corona discharge ozone generator, an ultraviolet ozone generator, or a plasma ozone generator.

26. The method of claim 16, further comprising a step of directing the gas in the reactor through a heater, a catalyst, or an activated carbon.
